(19) United States
(12) Patent Application Publication
(10) Pub. No.: US 2012/0090776 A1
(43) Pub. Date: Apr. 19, 2012

(54) METHOD AND APPARATUS FOR CURVED CIRCULARLY POLARIZED LENS

(76) Inventor: Roger Wen-Yi Hsu, Rancho Cucamonga, CA (US)

(21) Appl. No.: 13/274,263

(22) Filed: Oct. 14, 2011

Related U.S. Application Data
(60) Provisional application No. 61/393,281, filed on Oct. 14, 2010.
(60) Provisional application No. 61/393,284, filed on Oct. 14, 2010.

(51) Int. Cl. B32B 37/14; B32B 38/10; B32B 37/10; B32B 37/12; B32B 37/02

(52) U.S. Cl. 156/242; 156/285; 156/250; 156/497

(57) ABSTRACT

A curved circularly polarized lens is used in a passive 3D system to view 3D multimedia. The lens is created in an advanced delicate process whereby two lens pieces are combined with a special glue and molded to a specific conformation. This unique method of production of curved circularly polarized lenses retains the molecular arrangement of the lens, reduces or eliminates optical distortion and physical warping, and eliminates movement between the lens layers.

### CROSS REFERENCE TO RELATED APPLICATIONS

This application claims the benefit of U.S. provisional application Ser. No. 61/393,281 filed on Oct. 14 2010 and U.S. provisional application Ser. No. 61/393,284 filed on Oct. 14 2010, the disclosures of which are incorporated herein by reference.

### BACKGROUND OF THE INVENTION

1. Technical Field

The present invention pertains to special lenses used for viewing 3D multimedia.

In particular, the present invention pertains to the use of curved circularly polarized lenses which are produced in a unique process that retains the molecular structure and alignment of the lens, reduces or eliminates optical distortion, and eliminates physical warping. The lenses are used in passive 3D systems to view still and moving images.

2. Discussion of Related Art

One of the greatest challenges facing multimedia producers is the balance of comfort, optical integrity, and user adaptability of 3D glasses. Several competing formats of 3D glasses offer distinct advantages and disadvantages due to the production methods for the lenses and the physical characteristics and capabilities of the lenses. One example of a less effective competing 3D lens format is the linearly polarized lens.

Linearly polarized glasses allow a user to view stereoscopic pictures when two images are superimposed onto a screen through orthogonal polarizing filters in an image projector. The filters are usually positioned at 45 degrees and 135 degrees. The viewer wears linearly polarized glasses which also contain a pair of orthogonal polarizing filters in the same orientation as the projector. With this method, each filter passes only light which is similarly polarized and blocks orthogonally polarized light. Each of the user's eyes can only see one of the projected images, and thus, the 3D effect is achieved. However, when using linearly polarized glasses, the user must constantly maintain his head position in order to consistently experience the 3D effect. Should the user tilt his head while wearing the 3D glasses, the tilting of the filters in the glasses will cause the images of the left and right channels to bleed over into the opposite channel. Moreover, tilting of the user's head while wearing linearly polarized 3D glasses also causes failure of the polarization, ghosting, and both eyes seeing both images of the stereoscopic media. This characteristic of linearly polarized glasses causes discomfort to users over prolonged viewing periods because the user cannot move his head in order to maintain a consistent 3D effect.

Accordingly, a need in the art exists to improve the user comfort, user mobility during 3D media viewing, and optical clarity of 3D glasses. No current 3D lens technology exists that allows a user to tilt and rotate his head during 3D media viewing while maintaining a consistent 3D effect.

### OBJECTS OF THE INVENTION

Accordingly, it is the object of the invention to provide a comfortable 3D media viewing experience for short or prolonged viewing periods.

It is another object of the invention to provide 3D glasses that allow for normal user head movement during viewing of 3D media without causing optical distortion or interruption of the 3D effect.

Yet another object of the invention is to provide 3D glasses with structural integrity thanks to a unique lens binding process.

Another object of the invention is to prevent optical distortion and increase structural integrity in the 3D glasses through a unique lens shape conformation process.

Another object of the invention is to enhance optical clarity and reduce or eliminate optical distortion in the 3D lenses by employing a special process of producing the 3D lenses such that the molecular alignment is retained throughout the process.

The present invention may be used in conjunction with televisions, computer monitors, theater projection screens, and other media.

The present invention may utilize lens tint to enhance color perception, depth perception, and optical clarity.

The above and still further features, objects, and advantages of the present invention will become apparent upon consideration of the following detailed description of specific embodiments thereof, especially when considered in conjunction with accompanying drawings wherein in like reference numerals in the various figures designate like components.

### SUMMARY OF THE INVENTION

In one aspect, the invention discloses a method to form 3D glasses lens comprising: providing a retarder film, providing a polarized film, providing a high adhesion glue having a peel adhesion rate of at least 600 g/cm, applying the glue to a first surface to the retarder film, attach the polarized film to the first surface of the retarder film to form a circular polarized film, applying heat to the circular polarized film until it is soft, applying pressurized air to the circular polarized film and vacuuming the pressurized air as the pressurized air passes through the circular polarized film.

In one embodiment, the invention further comprising cutting the circular polarized into lens shape to form circular-polarizer3D lens. In yet another embodiment, it further comprising adding a substrate layer to the circular-polarizer3D lens using glue with lamination method.

In yet another embodiment it further comprising adding a substrate to the circular polarized using a casting method. In yet another embodiment the casting method is comprised of: providing a bottom casting mold, providing a top casting mold, providing a o-ring, placing the o-ring around the edges of the bottom casting mold, placing a first quantity of liquid epoxy on to the bottom casting mold, placing the circular-polarizer3D lens over the first liquid epoxy, applying a second quantity of epoxy liquid on to the circular-polarizer3D lens, applying the top casting mold onto the second liquid epoxy, allowing the first and second liquid epoxy to dry to form epoxy-circular-polarizer3D lens wherein the epoxy-circular-polarizer3D lens' thickness is determined by hight of the o-ring, removing the epoxy-circular-polarizer3D lens from the casting molds after a duration of time.

In yet another embodiment, the casting method is comprised of providing a bottom casting mold, providing a top casting mold, providing a supporter, placing the supporter around the edges of the bottom casting mold, placing a first quantity of liquid epoxy on to the bottom casting mold, placing the circular-polarizer3D lens over the first liquid epoxy, applying a second quantity of epoxy liquid on to the circular-polarizer3D lens, applying the top casting mold onto the second liquid epoxy wherein the top casting mold rests on the supporter, allowing the first and second liquid epoxy to dry to form epoxy-circular-polarizer3D lens wherein the epoxy-circular-polarizer3D lens' thickness is determined by height of the supporter, removing the epoxy-circular-polarized 3D lens from the casting molds.

In yet another embodiment, casting method is disclosed comprised of providing a rim-lock like apparatus wherein the apparatus is comprised of a bottom rim-lock mold, a top rim-lock mold, a divider and a clipping apparatus, placing a first quantity of liquid epoxy on to the bottom rim-lock mold, placing the circular-polarizer3D lens over the first liquid epoxy, applying a second quantity of epoxy liquid on to the circular-polarizer3D lens, applying the top rim-lock mold onto the second liquid epoxy wherein the the top rim-lock mold sits on the divider, clipping the top rim-lock mold with the bottom rim-lock mold with the clipping apparatus wherein the, allowing the first and second liquid epoxy to dry to form epoxy-circular-polarizer3D lens wherein the epoxy-circular-polarizer3D lens' thickness is determined by height of the divider, removing the epoxy-circular-polarizer3D lens from the top and bottom rim-lock molds.

In yet another embodiment, the casting method further comprises an injection tube where in the liquid epoxy is applied using the injection tube. In yet another embodiment, the adhesion glue is selected from the group consisted of acrylonirile, acrylic, polymer, polyacrylamide, epoxy, eva and polyurethane.

In yet another embodiment, the application of heat further comprises pre-heating the circular polarized film for approximately 20-30 seconds. In yet another embodiment the heat is approximately 120-200 degree fahrenheit. In yet another embodiment, the pressurized air is pressured at approximately 2 kg/cm to 5 kg/cm.

In yet another embodiment, the method is carried using an apparatus for assembly of layered lens disclosed in this disclosure. In yet another embodiment, the duration time is approximately 10-30 hours. In yet another embodiment, the liquid epoxy can be replaced by other compatible liquid film materials.

In yet another embodiment, the retarder can be replaced by polymer sheet to be attached to the polarized film using the same above methods to create a linear polarized film for use for 3D lenses.

In another aspect of the present invention, an apparatus for assembly of layered lens is disclosed comprising, a first mold comprising one or more holes in the mold, a second mold comprising one or more holes in the mold, the first mold capable of closing onto the second mold in a sealed manner and holding one or more polymer films within the first and second molds in a sealed manner, an air input providing external pressurized air through the first mold holes wherein the pressurized air further passes through the polymer films, a vacuum pump vacuuming the external pressurized air through the second mold holes, a heating source to heat the first and second molds.

In yet another embodiment, the heating source pre-heats the first or second molds before the polymer films are placed in the first or second molds. In yet another embodiment, the method, the heating source heats pre-heats the first or second molds for 20-30 seconds. In yet another embodiment, the method the heat is approximately 120-200 degree Celsius. In yet another embodiment, the method the pressurized air is pressured at approximately 2 kg/cm to 5 kg/cm. In yet another embodiment, the id pressurized air is heated to 250-300 degree Celsius.

In yet another embodiment, the vacuum pump is built as one unit with the second mold. In yet another embodiment, the input is built as one unit with the first mold.

In yet another embodiment, the apparatus further including a cylinder capable of moving the first mold vertically to close onto the second mold. In yet another embodiment, the, the apparatus further including a cylinder capable of moving the second mold vertically to close onto the first mold.

### BRIEF DESCRIPTION OF THE DRAWINGS

FIG. 1 is a diagram showing the procedural steps of combining layers of retarder and polarized film.

FIG. 2 is a diagram showing the placement of various layers of polymer.

FIG. 3 is a diagram showing the placement of various layers of polymer and additives in the succeeding step of the procedure.

FIG. 4 is a diagram showing the placement of various layers of polymer and additives in the succeeding step of the procedure.

FIG. 5 is a diagram of a molding apparatus with a vacuum chamber for shaping the lens.

FIG. 6 is a diagram of the pre-heating stage of forming the lens.

FIG. 7 is a diagram of the succeeding step in the procedure of forming the lens within the apparatus, wherein air is vacuumed out and pumped in simultaneously.

FIG. 8 is a diagram of die-cutting of the lens.

FIG. 9 is a diagram of the laminate substrate method of adding a substrate lens.

FIG. 10 is a diagram of the casting method.

FIG. 11 is a diagram of the O-ring controller for a mold.

FIG. 12 is a continuation of the above diagram.

FIG. 13 is a continuation of the sequential steps of the above diagram.

FIG. 14 is a diagram of the supporter.

FIG. 15 is a diagram of the next step of the procedure involving the supporter.

FIG. 16 is a diagram of procedural steps in the rim-lock method with epoxy drops.

FIG. 17 is a diagram of the next step of the rim-lock method.

FIG. 18 is a diagram of the next step of the rim-lock method.

FIG. 19 is the rim-lock method with epoxy injection procedural diagram.

### DETAILED DESCRIPTION OF THE PREFERRED EMBODIMENTS

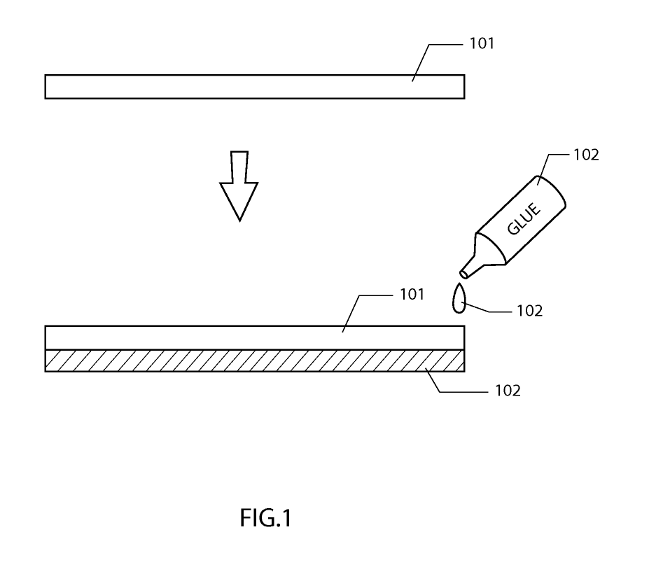

Referring to FIG. 1, which is a visual flow diagram of the method of laminating retarder film 101 and polarized film together 104. To laminate the retarder film 101 and polarized film 104 together, a special glue 102 with adhesive index above 600 g/cm² is used in order to prevent movement or uneven stretching between the layers. The retarder film 101 is combined with the polarized film 104 to create a polarized lens.

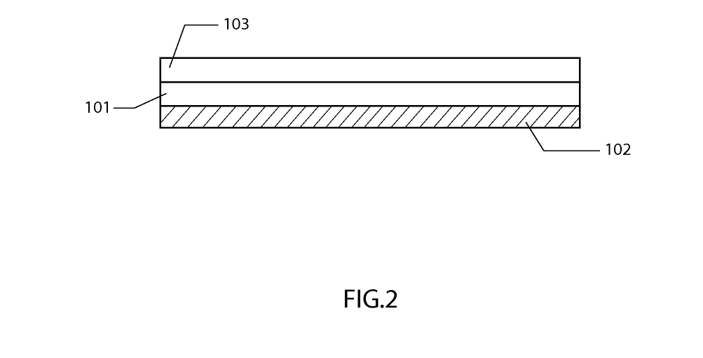

Now referring to FIG. 2, which is a continuation of the above visual flow diagram sequentially tracing the process of laminating retarder film. Here it illustrates (pressure sensitive adhesive) PSA 103 as on top of the retarder 101. PSA is usually provided and applied to the commercially available retarder films. Its quality is similar to adhesive tapes and has poor adhesive rating and not able to keep the layer in place. In this diagram, it is shown that the top layer PSA 103 is applied already to the retarder 101 and the bottom surface of the retarder 101 is re-treated with glue 102.

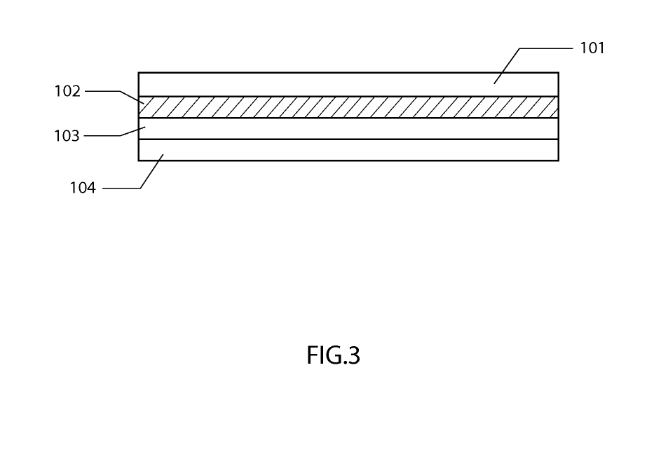

Referring to FIG. 3, which is a continuation of the above visual flow diagram sequentially tracing the process of laminating retarder film, the combined layers now include the retarder 101, an applied layer of glue 102, (pressure sensitive adhesive) PSA 103, and a polarized film layer 104. As stated earlier, while PSA 103 are typically applied and included to commercially available retarder, PSA 103 is also applied and included to commercially available polarized film 104. In this embodiment, it is shown that the glue 102 can applied directly on to PSA 103 which is attached to the polarized film. The glue 102 is added for immediate use or after heat application and hardening of the layers. Examples of glue used include but are not limited to acrylonirile, acrylic, polymer, polyacrylamide, epoxy, EVA, and polyurethane. The glue must have peel adhesive value of no less than 600 g/cm.

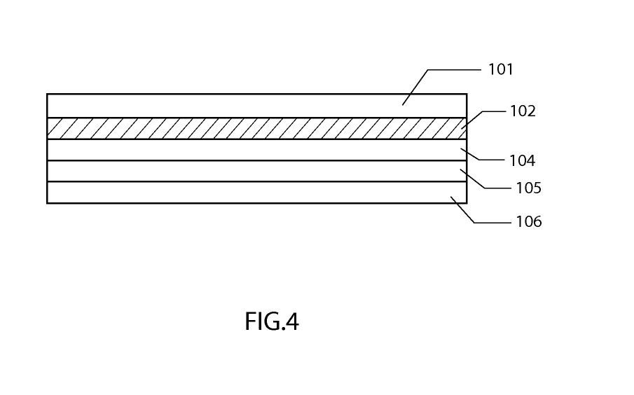

Now, referring to FIG. 4, in another embodiment, the retarder 101 is combined with a layer of special glue 102, and then with a commercially available polarized film which includes a first layer of TAC (Triacetate) 104, a layer of PVA (Polyvinyl alcohol Film) 105, and another layer of TAC 104 are added below.

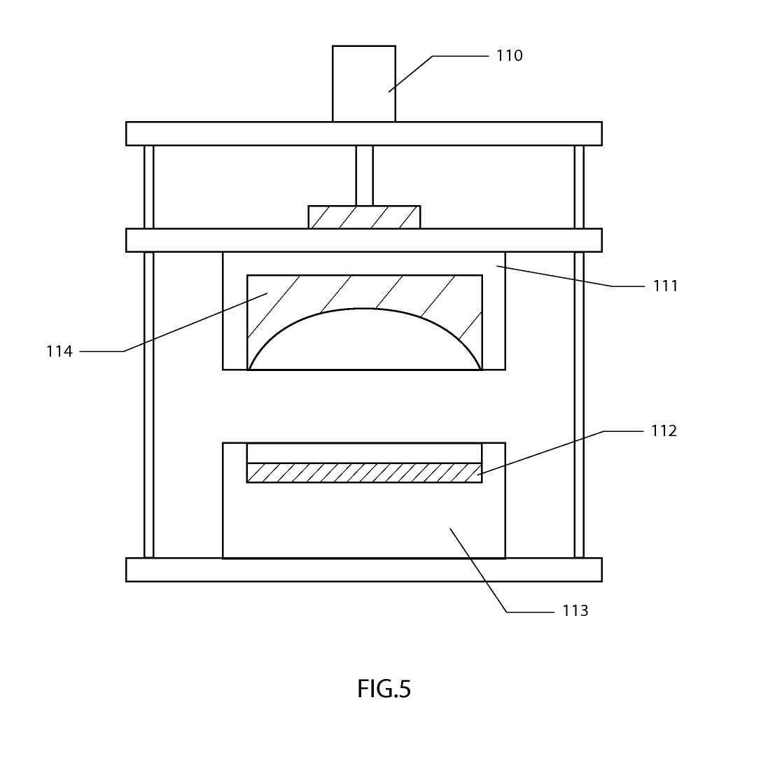

Referring to FIG. 5, which a diagram of an apparatus for molding the lens in a vacuum chamber, the cylinder 110 is moved upwards and downwards along a vertical axis, which moves the top mold chamber 111 having the top mold 14 so it can close onto the bottom mold chamber 113 having a bottom mold 112. An input of air for external air can in incorporated into the bottom mold chamber 113 and introduce pressurized air, preferably at 250-300 Degree Celsius and at 2-5 kg/cm pressure, into the bottom mold 112 wherein the mold 112 would have one more many holes to channel the air upwards. An air vacuum pump can be built into the top mold chamber 111 and sucks up the pressurized and heated air. Once the retarder and polarized lens are combined, they are introduced into this apparatus. The apparatus is preferably pre-heated for 20-30 seconds and at preferably 120-200 degree C. When the retarder and circularly polarized layers are soft, the top half of the apparatus vacuums air out, while the bottom half of the apparatus introduces 250-300 degree Celsius heat and pressure onto the lens.

Best way for good quality is to have vacuum air out and compress air in at the same time. Ideal amount of time to do this is approximately 5-20 seconds.

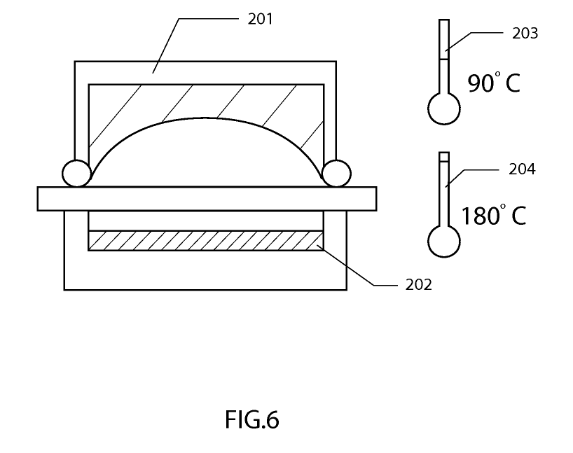

FIG. 6 is a diagram illustrates one embodiment of the pre-heating stage of the mold process for making curved circularly polarized lens before pressurized air is introduced. Here, the top mold 201 chamber is stabilized at 90 degrees Celsius as indicated by 203, and the bottom mold 202 is stabilized at 180 degrees Celsius as indicated by 204.

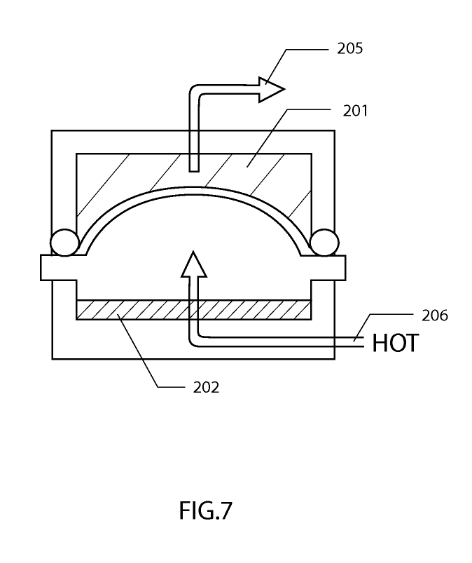

Now referring to FIG. 7, which is a continuation of the process in FIG. 6. After the circular polarized lens becomes soft, hot air is vacuumed out 205 of the top mold 201. Compressed hot air 206 is pumped into the bottom mold 202 at the rate of 3 kg/cm². These processes are carried out simultaneously for optimal results.

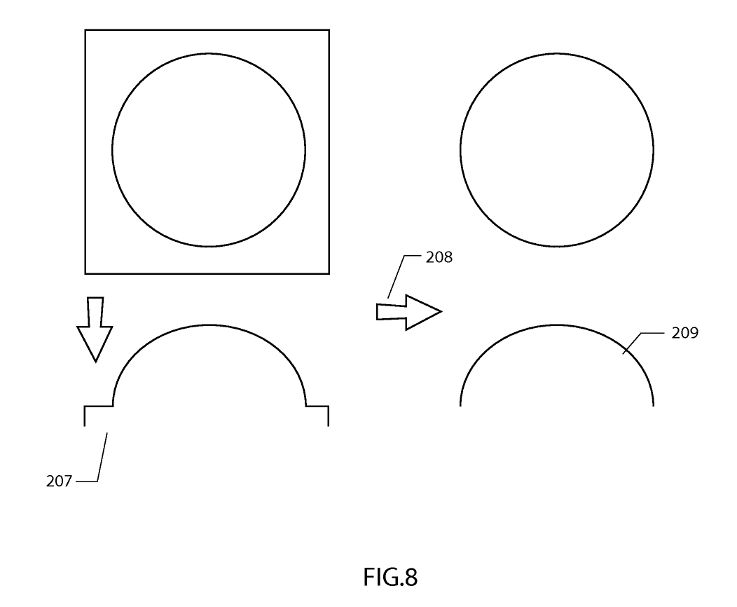

Referring to FIG. 8, which is a diagram of die-cutting, 207 the lens must be pressed firmly to hold it stationary and prevent movement in order to ensure a high quality and precise cut. After the die-cut 208, the polymer sheet on the convex side 209 is retrieved.

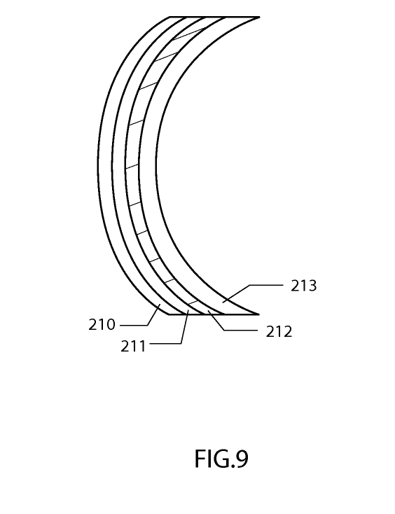

Referring to FIG. 9, which is a diagram of the laminate substrate method of adding a substrate lens, epoxy 210 is added to a layer of polarized film 211, glue 212, and pre-formed substrate 213 (including but not limited to epoxy, PU, PC, AC, nylon, CR39).

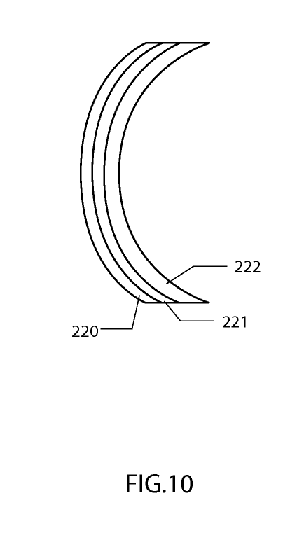

Referring to FIG. 10, which is a diagram of the casting method which there are four types to control the thickness of the substrate. Here, epoxy 220 is added to polarized film 221 and pre-formed substrate 222 (including but not limited to epoxy, PU, PC, AC, nylon, CR39).

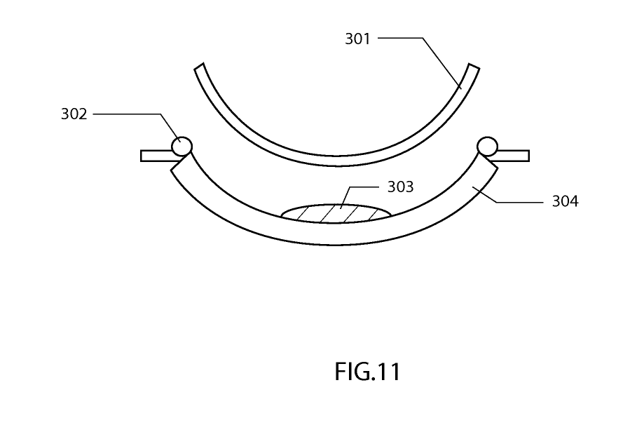

Referring to FIG. 11, which is a diagram of the 0-ring controller for a mold, the circularly polarized film 301 is placed upon epoxy liquid 303 applied to the bottom mold 304. The O-ring 302 is constructed of PU (polyurethane) or silicon may be adjusted to control the thickness of the lens.

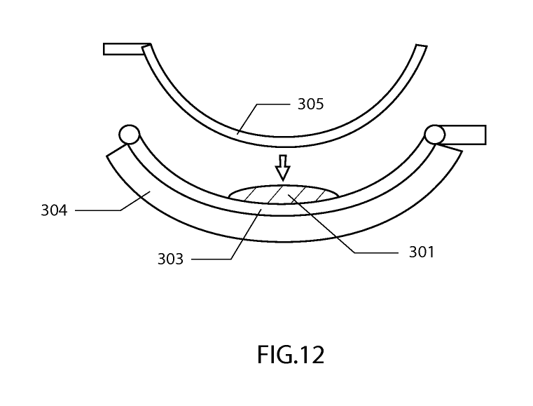

Referring to FIG. 12, which is a continuation of the above diagram, the top mold 305 is placed upon the circularly polarized film 301 which rests above a layer of epoxy 303 upon the bottom mold 304.

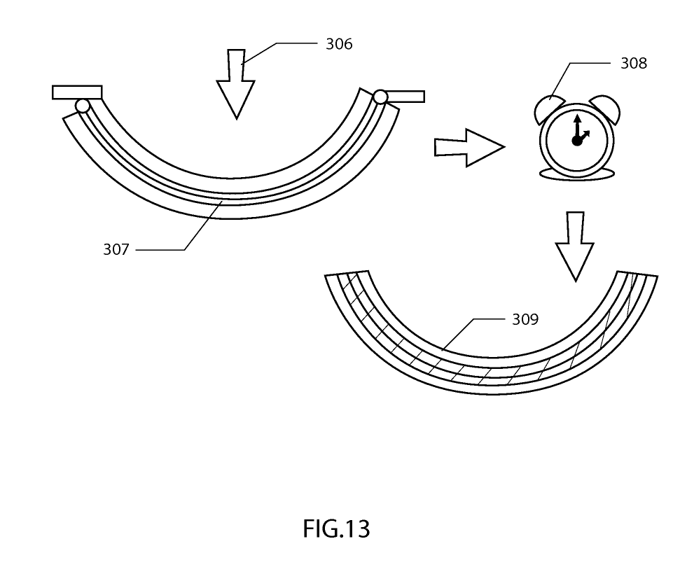

Referring now to FIG. 13, which is a continuation of the sequential steps of the above diagram, 306 the molds are pressed together in order to shape the circularly polarized lens 307. A waiting period 308 occurs, during which the curing process occurs. The mold may be removed after 10-30 hours. After 30-72 hours, the lens will be fully set and the finished product 309 is hardened and removed.

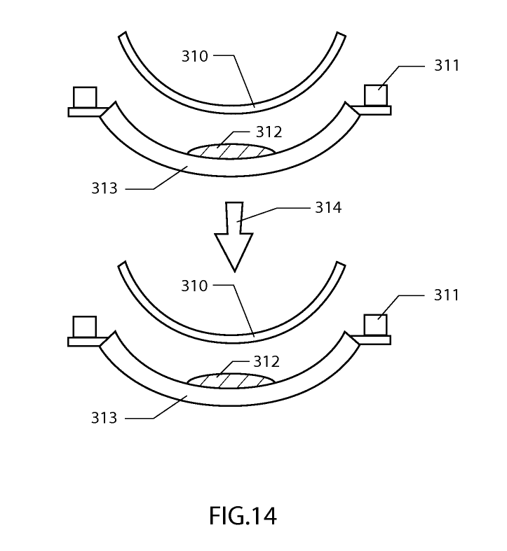

Referring to FIG. 14, which is a diagram of the supporter, the circularly polarized lens 310 is placed upon a layer of epoxy liquid 312 on top of the bottom mold 313. A leg 311 on either end of the mold lends support in the vertical direction. In the following step 314, the circular polarized layer 310 is placed upon the readied mold.

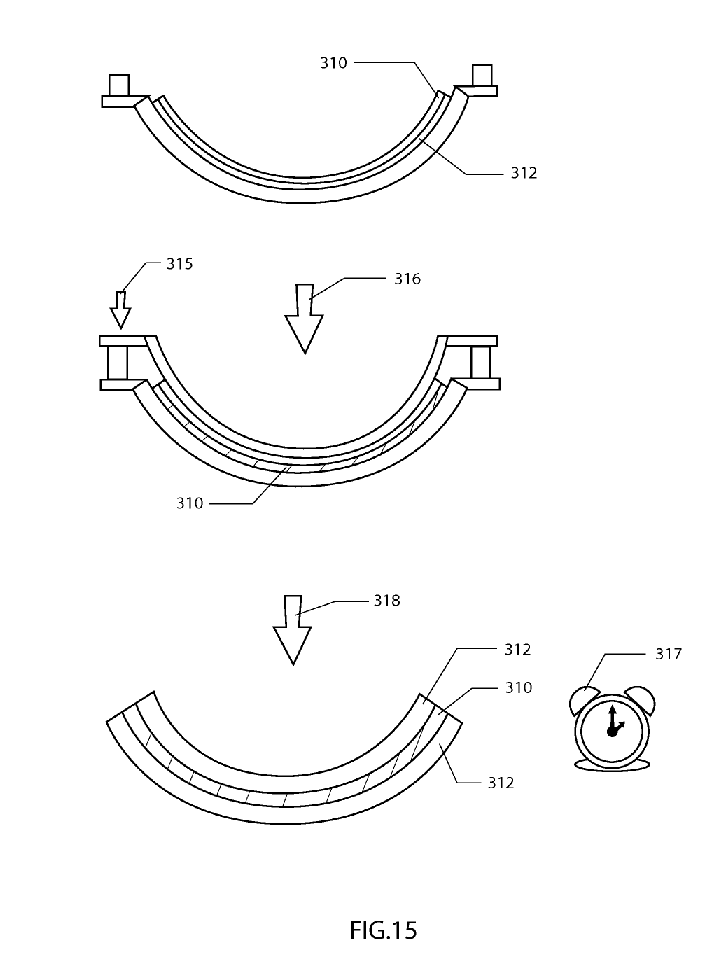

Referring to FIG. 15, which is a diagram of the next step of the procedure involving the supporter, the polarized layer 310 has been placed atop the epoxy layer 312 on the mold. In the following step 316, the two molds are pressed together with the polarized layer 310 sandwiched in between. Then, in the next step 318, the polarized layer is sandwiched between two layers of epoxy 312. A waiting period of 10-30 hours commences 317. The curing process occurs and the mold may then be removed. The lens will then be fully set.

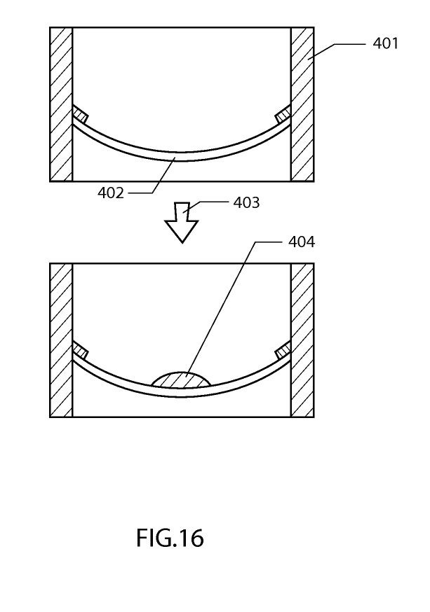

Referring to FIG. 16, which is a diagram of procedural steps in the rim-lock method with epoxy drops, a rim-lock 401 is attached on either side of a bottom glass mold 402. In the following step 403, epoxy 404 is added on top of the glass mold.

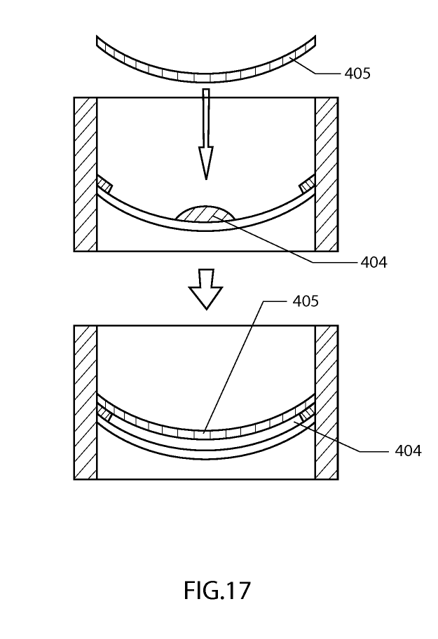

Referring now to FIG. 17, which is a diagram of the next step of the rim-lock method, a curved circularly polarized layer 405 is added on top of the epoxy 404.

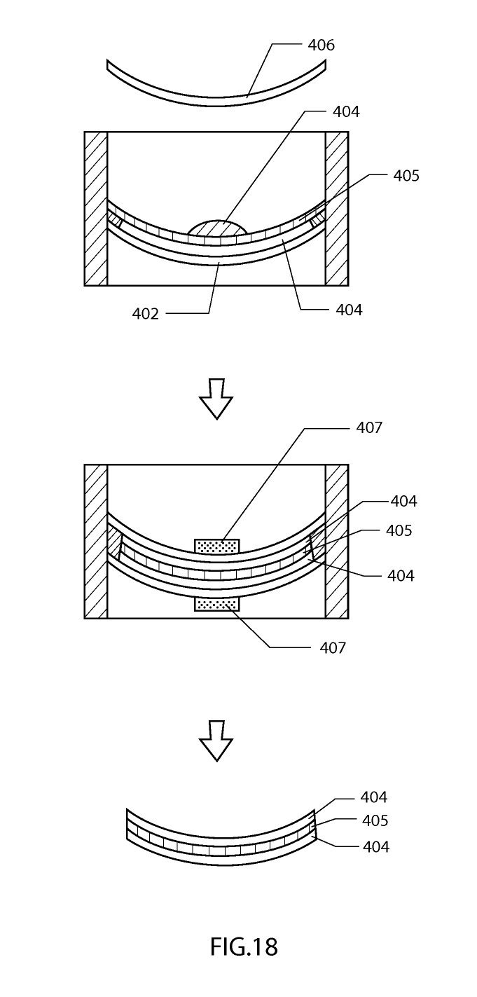

Referring now to FIG. 18, which is a diagram of the next step of the rim-lock method, an upper glass mold 406 is pressed downwards upon an additional layer of epoxy 404 over the circularly polarized layer 405. In the following step, clippers 407 are used to secure the combined layers together firmly. The layers now include a circularly polarized layer 405 sandwiched in between layers of epoxy 404. Following a waiting period of 48 hours, the finished product is removed from the mold and includes a cured circularly polarized layer 405 sandwiched between layers of epoxy 404.

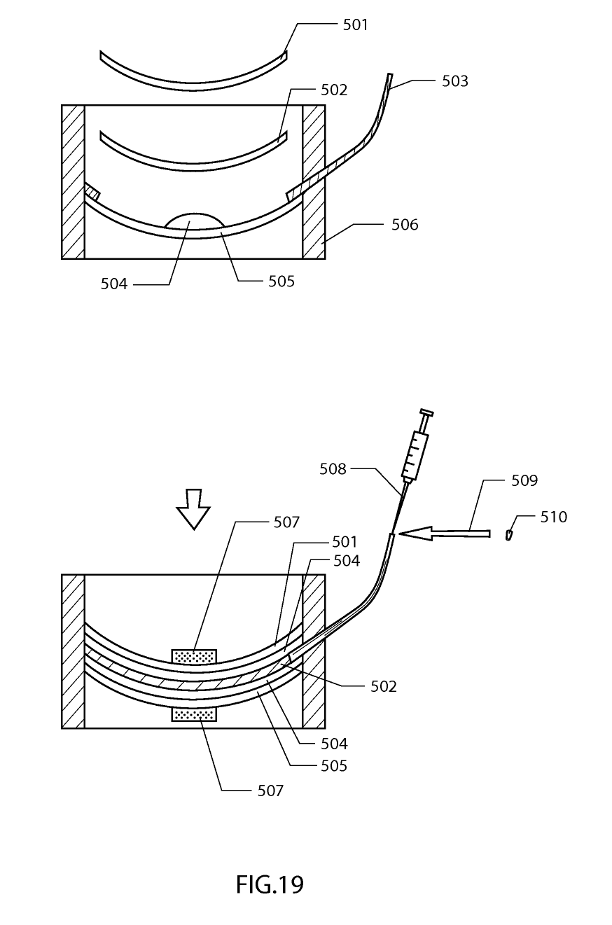

Referring now to FIG. 19, which is the rim-lock method with epoxy injection procedural diagram, a rim lock 506 is attached to either side of a bottom glass mold 505. Epoxy 505 is introduced into the system above the bottom mold 505 via an epoxy injection tube 503. Then, a circularly polarized layer 502 is placed upon the epoxy 504, and a top glass mold 501 is pressed down upon the entire combination of layers. In the following sequential diagram, a clamp 507 secures the combination of layers, which now include the top mold 501, two layers of epoxy 504 surrounding a circularly polarized layer 502, and a bottom mold 505. The epoxy was injected into the system via a dropper or syringe-like device 508 in the preceding step 509. A cap 510 plugs the epoxy injection port after epoxy injection.

What is claimed is:

1. A method to form 3D glasses lens comprising:
a. providing a retarder film,
b. providing a polarized film,
c. providing a high adhesion glue having a peel adhesion rate of at least 600 g/cm,
d. applying said glue to a first surface to said retarder film,
e. attaching said polarized film to said first surface of said retarder film to form a circular polarized film,
f. applying heat to said circular polarizer film until it is soft,
g. applying pressurized air to said circular polarized film,
h. vacuuming said pressurized air as said pressurized air passes through said circular polarized film.

2. The method of claim 1, further comprising cutting said circular polarized film into lens shape to form a circular polarized 3D lens.

3. The method of claim 2, further comprising adding a substrate layer to said circular polarized 3D lens using glue with lamination method.

4. The method of claim 2, further comprising adding a substrate to said circular polarizer using a casting method.

5. The method of claim 4, wherein said casting method is comprised of:
a. providing a bottom casting mold,
b. providing a top casting mold,
c. providing a o-ring,
d. placing said o-ring around the edges of said bottom casting mold,
e. placing a first quantity of liquid epoxy on to said bottom casting mold,
f. placing said circular polarized 3D lens over said first liquid epoxy,
g. applying a second quantity of epoxy liquid on to said circular polarized 3D lens,
h. applying said top casting mold onto said second liquid epoxy,
i. allowing said first and second liquid epoxy to dry to form epoxy-circular-polarized 3D lens wherein said epoxy-circular-polarized 3D lens' thickness is determined by hight of said o-ring,
j. removing said epoxy-circular-polarized 3D lens from said casting molds after a duration of time.

6. The method of claim 4 wherein said casting method is comprised of:
a. providing a bottom casting mold,
b. providing a top casting mold,
c. providing a supporter,
d. placing said supporter around the edges of said bottom casting mold,
e. placing a first quantity of liquid epoxy on to said bottom casting mold,
f. placing said circular-polarized 3D lens over said first liquid epoxy,
g. applying a second quantity of epoxy liquid on to said circular polarized 3D lens,
h. applying said top casting mold onto said second liquid epoxy wherein said top casting mold rests on said supporter,
i. allowing said first and second liquid epoxy to dry to form epoxy-circular-polarized 3D lens wherein said epoxy-retarder-polarizer 3D lens' thickness is determined by height of said supporter,
j. removing said epoxy-circular-polarized 3D lens from said casting molds.

7. The method of claim 4 wherein said casting method is comprised of:
a. providing a rim-lock like apparatus wherein said apparatus is comprised of a bottom rim-lock mold, a top rim-lock mold, a divider and a clipping apparatus,
b. placing a first quantity of liquid epoxy on to said bottom rim-lock mold,
c. placing said circular polarized 3D lens over said first liquid epoxy,
d. applying a second quantity of epoxy liquid on to said circular polarized 3D lens,
e. applying said top rim-lock mold onto said second liquid epoxy wherein said said top rim-lock mold sits on said divider,
f. clipping said top rim-lock mold with said bottom rim-lock mold with said clipping apparatus wherein said epoxy-retarder-polarizer 3D lens' thickness is determined by height of said divider,
g. allowing said first and second liquid epoxy to dry to form epoxy-circular-polarized 3D lens wherein said epoxy-circular-polarizer 3D lens' thickness is determined by height of said divider,
h. removing said epoxy-circular-polarizer 3D lens from said top and bottom rim-lock molds.

8. The method of claim 7 wherein said casting method further comprises an injection tube where in said liquid epoxy is applied using said injection tube.

9. The method of claim of 1 wherein said adhesion glue is selected from the group consisted of acrylonirile, acrylic, polymer, polyacrylamide, epoxy, eva and polyurethane.

10. The method claim of 1 wherein said application of heat further comprises pre-heating said circular polarized film for approximately 20-30 seconds.

11. The method claim of 1 wherein said heat is approximately 120-200 degree Celsius.

12. The method of claim 1 wherein said pressurized air is pressured at approximately 2 kg/cm to 5 kg/cm.

13. The method of claim 1 is carried out in the apparatus of claim 5.

14. The method of claim 5 wherein said duration time is approximately 10-30 hours.

15. The method of claim 5, 6 or 7 wherein said liquid epoxy can be replaced by other compatible liquid film materials.

16. An apparatus for assembly of layered lens comprising:
a. a first mold comprising one or more holes in said mold,
b. a second mold comprising one or more holes in said mold,
c. said first mold capable of closing onto said second mold in a sealed manner and holding one or more polymer films within said first and second molds in a sealed manner,
d. an air input providing external pressurized air through said first mold holes wherein said pressurized air further passes through said polymer films,
e. a vacuum pump vacuuming said external pressurized air through said second mold holes,
f. a heating source to heat said first and second molds.

17. The apparatus of claim 16 wherein said heating source pre-heats said first or second molds before said polymer films are placed in said first or second molds.

18. The apparatus of claim 17 wherein said heating source heats pre-heats said first or second molds for 20-30 seconds.

19. The apparatus claim of 17 wherein said heat is approximately 120-200 degree Celsius.

20. The apparatus of claim 16 wherein said pressurized air is pressured at approximately 2 kg/cm to 5 kg/cm.

21. The apparatus of claim 16 wherein said pressurized air is heated to 250-300 degree Celsius.

22. The apparatus of claim 16 wherein said vacuum pump is built as one unit with said second mold.

23. The apparatus of claim 16 wherein said input is built as one unit with said first mold.

24. The apparatus of claim 16 further including a cylinder capable of moving said first mold vertically to close onto said second mold.

25. The apparatus of claim 16 further including a cylinder capable of moving said second mold vertically to close onto said first mold.

26. The apparatus of claim 16 wherein said one or more polymer films is a retarder film.

27. The apparatus of claim 16 wherein said one or more polymer films is a polarized film.

28. The method of claim one wherein said retarder film can be replaced by a polymer film.

29. wherein said polymer film is attached to said polarized film to form a linear polarized film.
